(19) United States
(12) Patent Application Publication
(10) Pub. No.: US 2020/0340391 A1
(43) Pub. Date: Oct. 29, 2020

(54) AIR-COMPRESSING INTERNAL COMBUSTION ENGINE

(71) Applicant: AVL LIST GMBH, Graz (AT)

(72) Inventors: Alexander MACHOLD, Graz (AT); Ludwig BÜRGLER, Hitzendorf (AT); Herwig OFNER, Stübing (AT); Marina THELLIEZ, Graz (AT)

(73) Assignee: AVL List GmbH, Graz (AT)

(21) Appl. No.: 16/083,686

(22) PCT Filed: Feb. 21, 2017
(86) PCT No.: PCT/AT2017/060035

§ 371 Date: Sep. 10, 2018

(30) Foreign Application Priority Data
Mar. 10, 2016 (AT) A 50201/2016

(51) Int. Cl. F02B 23/06; F02B 23/10; F02F 3/26

(52) U.S. Cl. CPC F02B 23/0696; F02F 3/26; F02B 23/10

(57) ABSTRACT

The invention relates to an air-compressing internal combustion engine, comprising at least one piston (1) having a combustion chamber trough (3) substantially rotationally symmetrical to a piston axis (2), which has a trough bottom (4) with a substantially cone-like elevation (5) and a circumferential trough wall (6), wherein the trough wall (6) forms a substantially torus-like first section (6a) having a maximum inner first trough diameter (d1), a second section (6b) having a minimum inner second trough diameter (d2) smaller than the inner first trough diameter (d1), and a third section (6c), wherein—as seen in a meridian section of the piston (1)—the first section (6a) has a concave first radius of curvature (R1) and the second section (6b) has a convex second radius of curvature (R2), and wherein the third section (6c) forms a first annular surface (8) adjoining the second section (6b) and a second annular surface (9) terminating in the piston end surface (7), which second annular surface (9) defines an angle (β) with the first annular surface (8), wherein the first annular surface (8) and the second annular surface (9) are formed to be inclined to a normal plane (ε) on the piston axis (2), and wherein in the transition between the first annular surface (8) and second annular surface (9) an edge (11) is formed with a defined third radius of curvature (R3),

In order to prevent soot formation phenomena, it is provided that, as viewed in a meridian section of the piston (1), the first annular surface (8) together with a normal plane (ε) on the piston axis (2) forms a first angle (α) between 10° and 20°, preferably 15.2°.

The invention relates to an air-compressing internal combustion engine, comprising at least one reciprocating piston, in particular for swirl-free or low-swirl combustion, having a combustion chamber trough substantially rotationally symmetrical to a piston axis, which trough has a trough bottom with a substantially cone-like elevation and a circumferential trough wall, wherein the trough wall forms a torus-like first section adjoining the trough bottom and having a maximum inner first trough diameter, thereafter a second section forming a constriction and having a minimum inner second trough diameter smaller than the inner first trough diameter, and thereafter a third section forming a trough rim section, wherein—as seen in a meridian section—the first section has a concave first radius of curvature and the second section has a convex second radius of curvature, and wherein the third section forms a first annular surface adjoining the second section and a step formed by a second annular surface terminating in the piston end surface, which second annular surface defines an angle with the first annular surface, wherein the first annular surface and the second annular surface are formed to be inclined to a normal plane on the first annular surface, and wherein in the transition between the first and second annular surface an edge is formed with a defined third radius of curvature. Furthermore, the invention relates to an air-compressing internal combustion engine with at least one such piston, wherein in the region of the piston axis, an injection device is arranged so that at least one fuel jet meets the second section in at least one stroke position of the piston and the fuel jet is divisible through the second section into a first jet part directed towards the first section and a second jet part directed towards the third section.

From DE 10 2011 055 170 A1 a diesel engine piston with a combustion chamber is known, which has a profile surface which protrudes from its inner wall to a central axis of the combustion chamber and on the inner wall has a projection which extends with a predetermined length from the inner wall. The projection divides an injection fuel sprayed and atomized onto the projection into a fuel flow in an upper section and a fuel flow into a lower section of the combustion chamber. In this case, the combustion chamber trough comprises a core formed by a central elevation, which activates a swirl, vortex or spin forming the flow in the combustion chamber. As a result, the mixture of the fuel and the air, which flow into the combustion chamber, is improved and the mixing ratio can be increased.

DE 103 92 141 B4 describes a piston for an internal combustion engine, which surrounds a combustion trough with a fuel guide structure for diverting at least a section of the fuel leaving the combustion trough. The piston includes a sharp edge disposed on the outer surface of the piston adjacent to the access to the combustion trough, and a rounded fuel receiving lip located within the combustion trough.

Furthermore, EP 2 708 714 A2 discloses a combustion chamber for a diesel engine having a combustion chamber trough which has a concave shape such that an injected fuel jet creates a swirl or squish flow for mixing with air.

DE 10 2006 020 642 A1 describes a method for operating a direct-injection self-igniting internal combustion engine which has pistons each with a piston trough formed in a piston trough, which converges into a substantially annular step space in the transitional region to the piston. Injection jets of an injector are thus guided to the step space and deflected there such that a first partial quantity of fuel is deflected in an axial direction and in a radial direction into the piston trough, that a second partial quantity of fuel is deflected in the axial direction and the radial direction beyond the piston crown into the combustion chamber, and that a third partial quantity of fuel is deflected in a circumferential direction, wherein the respective third partial quantities of adjacent injection jets meet in the circumferential direction and are then directed in the radial direction inwardly. The wall of the step space is formed by an axially straight, cylindrical peripheral wall, by a flat bottom which is straight in the radial direction, as well as by a concavely curved transition wall. This should enable operation with reduced soot and smoke development. Although it is indicated that the peripheral wall may be tilted from +10° to −30° with respect to the axial direction and the bottom may be tilted in a range from +30° to −40° with respect to the radial direction, no explanation is given as to the purpose and effect of this measure.

CN 103 046 997 A shows a similar piston for a diesel internal combustion engine having a step space with an inclined bottom and a wall, wherein the bottom is inclined with respect to a normal plane on the piston axis at an angle between 8° and 12° and the wall is inclined with respect to the piston axis between 80° and 100°. As a result, in the area of the step space, a swirl of the injected fuel is produced, which is directed towards the combustion chamber ceiling and then towards the piston axis.

Documents CN 2010 74 556 Y, WO 2005/033496 A1 and CN 202 611 915 U disclose further similar pistons with step spaces for self-igniting internal combustion engines, wherein the trough wall of the step space adjoining the piston end side is formed parallel to the piston axis. Fuel jets of the injected fuel meeting the step of the piston are also deflected in this case in the direction of the combustion chamber ceiling and back again to the piston axis or trough axis.

The pistons described are designed especially for swirling combustion processes.

It has been found that in swirl-free combustion processes, the known pistons tend to considerable soot formation and soot deposition, since there are stagnation zones and fuel deposits in the region of the first section and the third section.

It is the object of the invention to avoid these disadvantages and to reduce soot formation phenomena on the piston in internal combustion engines of the type mentioned, in particular in swirl-free combustion.

According to the invention, this takes place in that—as seen in a meridian section of the piston—the first annular surface together with a plane normal to the piston axis forms a first angle between 10° and 20°, preferably 15.2°.

Thanks to the invention, the formation of a fat zone during combustion is prevented, which otherwise occurs, in particular during occurrence of swirling flows. The formation of soot is thus significantly reduced. The resulting swirling zones lead to a thermal relief of the cylinder head, since a lower heat input takes place.

Meridian section of the piston is understood to mean a section along the piston axis of the piston, which runs normal to the combustion chamber trough. The meridian section thus yields a meridian plane which is normal to the combustion chamber trough and is parallel to or coincident with the piston axis.

In complex experiments and calculations it has been recognized that in combination with the features mentioned, stagnation zones can be avoided on the trough walls in the third section when the first angle between the first annular surface and the normal plane on the piston axis is between 10° and 20°. The best results can be achieved when the first angle is just over 15°. Furthermore, in order to avoid soot formation in the region of the third section, it is particularly advantageous if, as viewed in a meridian section of the piston, the first annular surface encloses with the second annular surface a second angle between approximately 100° and 150°, preferably approximately 125°.

In particular, it is advantageous if the second annular surface defines with the piston axis a third angle between about 15° and 25°, preferably 21°. As a result, the fuel jet is guided along the second annular surface in the direction of the cylinder wall, wherein the direct contact with the cylinder wall can be avoided. This supports the maximum acquisition of available fresh gas charge for complete low-emission combustion. In this case, the fuel pulse generates a charge movement which is formed in the form of a rotation opposite to the injection jet. This takes place both in the area between the piston and the combustion chamber ceiling formed by the fire deck of the cylinder head, as well as between the piston and the trough bottom. The resulting rotating rollers are further fueled by the fuel jets and thus allow a nearly homogeneous fuel/air mixture. As a result, a good and low-emission combustion can be achieved.

The first and second annular surfaces, preferably designed as conical surfaces, form a step which deflects the fuel flow from the radial direction into an axial direction. The deflection between the first and second annular surface occurs abruptly. Surprisingly, it has been found that thereby substantially fewer soot formation phenomena can be observed than in the case of continuous deflection. This observation can be explained by the fact that as a result of the abrupt flow deflection in the axial direction, an increase in speed and a strong vortex or rolling motion around a tangential axis occurs, which immediately entrains depositing fuel or even prevents depositing. At least one injected fuel jet initiates a vortex or rolling motion respectively consisting of two opposing swirling rollers of air and fuel. In order to avoid deposits in the transition between the first and second annular surface, it is advantageous if—based on a largest diameter of the piston—the third radius of curvature is 0.012±50%.

In order to achieve a pronounced division into two jet parts, it is advantageous if the inner second trough diameter is at most about 95% of the diameter of the inner first trough diameter. For a division of the fuel jet, it is advantageous if—based on a largest diameter of the piston—the second radius of curvature is 0.02±50%.

Experiments have shown that particularly good results can be achieved when—based on the largest diameter of the piston—the combustion chamber trough in the region of the first section has an inner first diameter of about 0.7±20% (i.e. 0.7 times the largest diameter of the piston) and in the region of the second section has an inner second diameter of 0.65±20% (i.e. 0.65 times the largest diameter of the piston).

In order to produce a pronounced first swirling roller directed towards the trough bottom, it is advantageous if—based on a largest diameter of the piston—the first radius of curvature is 0.06±50% (i.e. 0.06 times the largest diameter of the piston).

A pronounced second swirling roller directed to the cylinder head is made possible when the first annular surface and/or the second annular surface are formed as a conical surface. The stepped third section and the angled annular surfaces reduce the thermal load of the fire deck of the cylinder head. Since the inlet channels generate no swirl and thus have lower flow losses, a higher charge mass can be entered through them into the combustion chamber. If the air/fuel ratio remains the same, more fuel can thus be supplied, thus making it possible to increase the maximum power at a given displacement. In addition, the piston design allows a reduced heat transfer to the piston and thus reduced heat losses on the piston.

In order to avoid soot formation phenomena in the third section, it may be provided that—based on a largest diameter of the piston—the third radius of curvature is 0.012±50% (i.e. 0.012 times the largest diameter of the piston).

The piston is suitable in particular for internal combustion engines with a swirl-free or low-swirl inlet channel structure, wherein a swirl number of the flow in the combustion chamber around the piston axis is at most 1. The inlet structure means the shape and arrangement of the intake passages formed in the cylinder head as low-swirl passages, which are designed so that little or no swirl is generated when the air flows into the combustion chamber.

In a preferred embodiment of the invention, the internal combustion engine operates according to a swirl-free combustion process. This includes a combustion process in which no or only a small inlet swirl is permitted or necessary, and which has substantially no charge rotation about the piston axis.

In comparison with a swirl-producing inlet structure, a swirl-free or low-swirl inlet structure has the advantage that flow losses can be reduced and thus the degree of delivery can be improved. This allows a higher maximum power for a given displacement. The inlet channels can be made simpler and shorter.

In a particularly advantageous embodiment variant of the invention, it is provided that, in a meridian section of the piston located at top dead center, at least one jet axis of the injection device divides the piston trough into a lower region adjoining the trough bottom of the piston and upper region adjoining said lower region in the direction of the combustion chamber ceiling, wherein the lower region is about 54% to 62%, preferably 56%, and the upper region is about 38% to 46%, preferably 44%, of the entire combustion chamber trough.

A particularly good mixing of the injection jets with fresh air can be achieved if the trough wall has a nose-like projection at least in an impact area of the fuel jet on the second section, wherein the projection preferably continues into the region of the first section and/or third section. The nose-like projection is preferably formed substantially symmetrically to a piston axis containing the radial axis of the piston.

The fuel jet is divided by the nose-like projection into a first jet arm and a second jet arm, wherein two mixture vortices arise under different directions of rotation. The jet splitting allows an optimal utilization of the available fresh air for combustion. As a result of the convexly rounded nose-like projection, the kinetic energy of the fuel jet can be deflected with as little loss as possible in the combustion chamber trough on both sides of the radial plane. The jet pulse of fuel jet and the shape of the nose-like projection of the trough wall produce a double swirling motion in the combustion chamber trough, in addition to the double rolling motion through the rib-like circumferential projection in the second section. All this in combination allows optimum utilization of the fresh air. The stepped design between the first annular surface and the second annular surface in the direction of the combustion chamber ceiling formed by the cylinder head distributes the impact of the hot combustion zone on the cylinder head to a larger area, thereby preventing or reducing a locally very high thermal load peak, thus reducing thermal load on the cylinder head.

The invention is explained in more detail below with reference to a non-limiting embodiment shown in the figures, wherein:

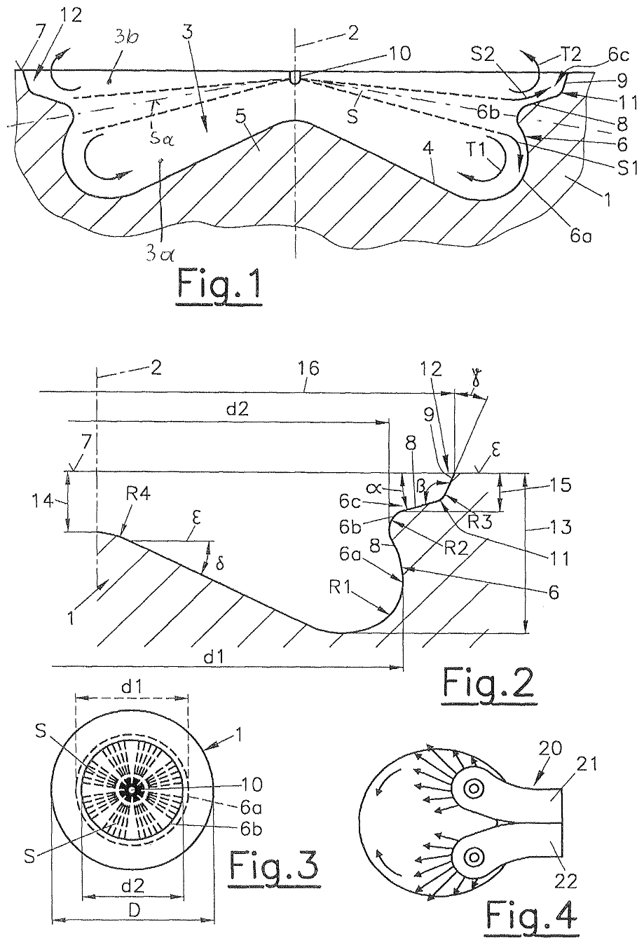

FIG. 1 shows a piston of an internal combustion engine according to the invention in a meridian section in a first embodiment;

FIG. 2 shows a detail of this piston;

FIG. 3 shows this piston in a plan view;

FIG. 4 shows a swirl-free or low-swirl inlet channel structure in a plan view;

FIG. 5 shows the flow situation in the combustion chamber of the piston in its top dead center;

FIG. 6 shows the flow situation in the combustion chamber of the piston at 10° after its top dead center;

FIG. 7 shows the flow situation in the combustion chamber of the piston at 20° after its top dead center;

FIG. 8 shows the flow situation in the combustion chamber of the piston at 40° after its top dead center;

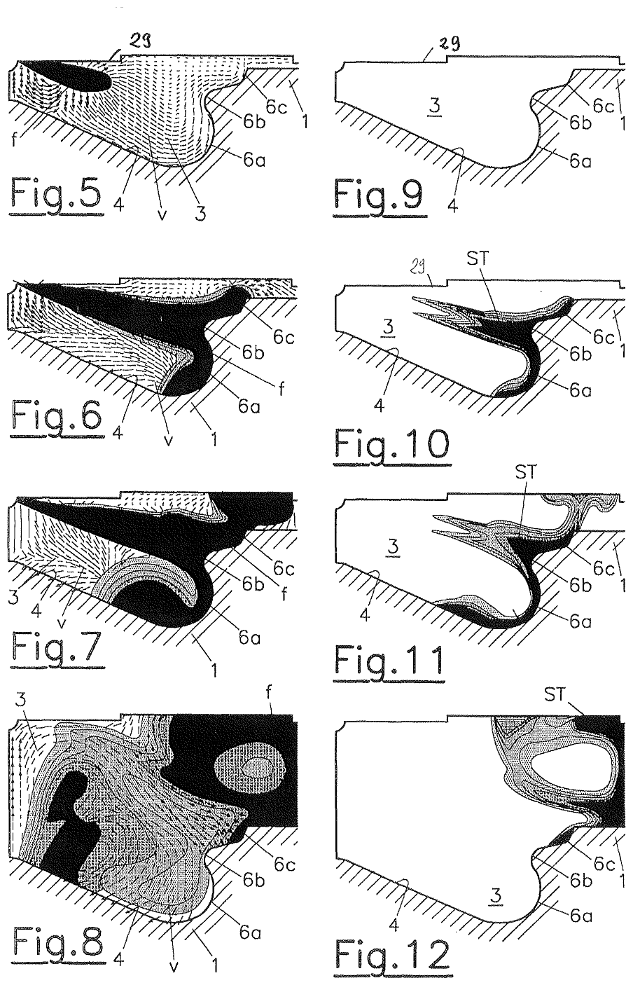

FIG. 9 shows the soot formation situation in the combustion chamber of the piston in its top dead center;

FIG. 10 shows the soot formation situation in the combustion chamber of the piston at 10° after its top dead center;

FIG. 11 shows the soot formation situation in the combustion chamber of the piston at 20° after its top dead center;

FIG. 12 the soot formation situation in the combustion chamber of the piston at 40° after its top dead center;

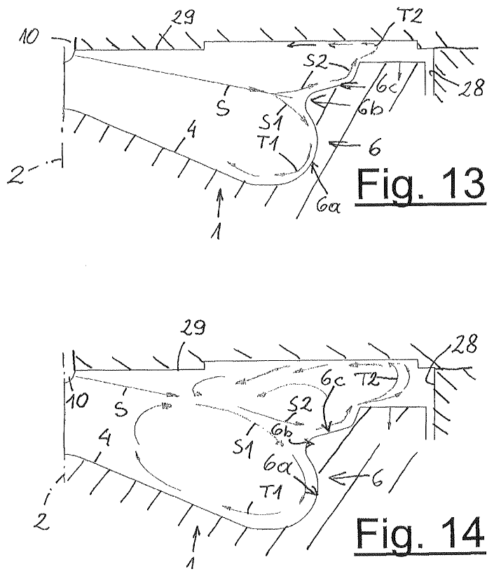

FIG. 13 shows the flow situation in the combustion chamber of the piston at 10° after its top dead center;

FIG. 14 shows the flow situation in the combustion chamber of the piston according to the invention at 25° after its top dead center;

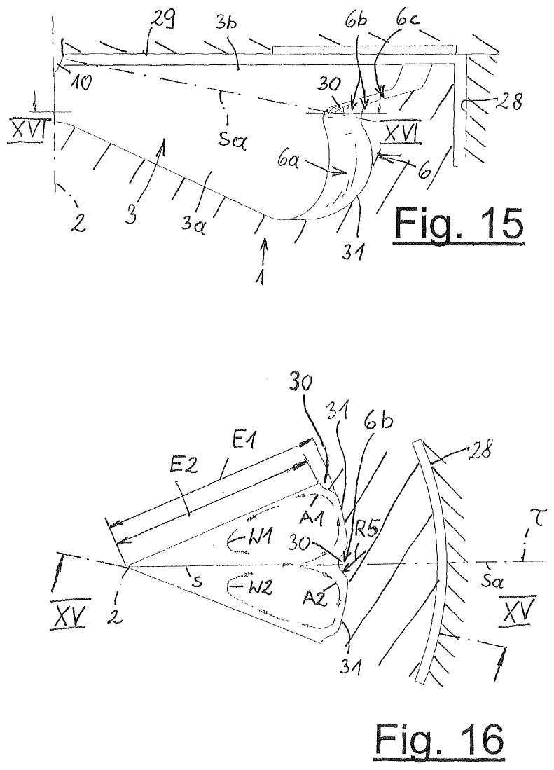

FIG. 15 shows a piston of an internal combustion engine according to the invention in a second embodiment variant in a meridian section along the line XV-XV in FIG. 16; and

FIG. 16 shows this piston in section along the line XVI-XVI in FIG. 15.

FIG. 1 shows a piston 1 of an air-compressing internal combustion engine (not shown in closer detail). The piston 1 is particularly suitable for internal combustion engines with swirl-free or low-swirl inlet channel structure 20, in particular for internal combustion engines with a swirl number in the combustion chamber of a maximum of 1, based on the piston axis 2. An example of a possible low-swirl or swirl-free inlet structure with inlet channels 21, 22 formed as low-swirl channels is shown in FIG. 4. The two inlet channels 21, 22 are formed symmetrically, so that the swirl components of the two inlet channels 21, 22 cancel each other out.

A combustion chamber trough 3 which is formed rotationally symmetrical to the piston axis 2 is formed in the piston 1. The combustion chamber trough 3 of the piston 1 which forms at least a large part of the combustion chamber consists of a trough bottom 4 with a cone-shaped central elevation 5, and a circumferential trough wall 6. Starting from the trough bottom 4, the trough wall 6 has a first section 6a, an adjoining second section 6b and a third section 6c adjoining the second section 6b, wherein the third section 6c adjoins the piston end face 7 facing the cylinder head (not shown) and forms a trough edge region 12.

In the first section 6a, the trough wall 6 is at least partially formed in the shape of a circular torus, wherein—as viewed in a meridian section of the piston 1—the concave first radius of curvature R1 of the first section 6a is about 0.06±50% of the largest diameter D of the piston 1. In the region of the first section 6a, the combustion chamber trough 3 has an inner first diameter d1 which is approximately 0.7±20% of the maximum diameter D of the piston 1. In the region of the second section 6b, the trough wall 6 is retracted and formed overhanging, wherein the inner second trough diameter d2 measured in the region of the second section 6b has a maximum of about 95% of the inner first trough diameter d1. Based on the maximum piston diameter D, the inner first trough diameter d1 is about 0.65±20%.

As viewed in the meridian sections of the piston 1 shown in FIGS. 1 and 2, the trough wall 6 is convexly curved in the second section 6b and has a second radius of curvature R2 of approximately 0.02±50% of the largest diameter D of the piston 1. The trough wall 6 is designed to extend between the first section 6a and the second section 6b, wherein it is also possible for a straight section 8 to be formed between the first radius of curvature R1 and the second radius of curvature R2. Alternatively, the first radius of curvature R1 may transition directly into the second radius of curvature R2 via a turning point.

The third section 6c of the trough wall 6 consists of a first annular surface 8 and a second annular surface 9, wherein the first annular surface 8 connects directly, i.e. continuously and transitionless, to the second radius of curvature R2 of the second section 6b and ends in the piston end face 7. The section line between the second annular surface 9 and the piston end face 7 in the exemplary embodiment has a diameter 16 which is approximately 80% of the largest diameter of the piston 1. Preferably, the first annular surfaces 8 and second annular surfaces 9 are formed by conical surfaces. In the meridian section of the piston 1 shown in FIGS. 1 and 2, the first annular surface 8 defines with a normal plane ε on the piston axis 2 a first angle α between approximately 10° and 20°, preferably 15.2°. The second annular surface 9 adjoining the first annular surface 8 is designed to be inclined to the first annular surface 8, wherein the first annular surface 8 encloses with the second annular surface 9 a second angle β between about 100° and 150°, preferably about 125°. With respect to the piston axis 2 or to a line parallel to the piston axis 2, the second annular surface 8 is formed inclined by a third angle γ between about 15° and 25°, preferably about 21°. Between the first annular surface 8 and the second annular surface 9, a defined edge 11 is formed. An abrupt transition between the first annular surface 8 and the second annular surface 9 formed by the edge 11 is advantageous in order to reduce the thermal load on the cylinder head. On the other hand, however, stagnation zones must be avoided in which fuel could accumulate. Experiments have shown that the best results can be achieved when the third radius of curvature R3 between the first annular surface 8 and the second annular surface 9 is at most about 0.012±50% of the largest diameter D of the piston 1.

In the exemplary embodiment illustrated, the maximum trough depth 13 is approximately 0.16 times the maximum diameter D of the piston 1 and the minimum trough depth 14 measured in the area of the central elevation 5 is approximately 0.061 times the maximum diameter D of the piston 1. The height of the second section 6b measured from the piston end face 7 in the direction towards the piston axis 2 is approximately 4% of the maximum diameter D of the piston 1. The conical elevation 5 defines an angle δ of approximately 20° to 30° with a normal plane on the piston axis 2, about 23° in the example. The elevation has a fourth radius of curvature R4, which is about 6% of the largest diameter D of the piston 1.

As indicated in FIG. 1, fuel is injected via an injection device 10 centrally disposed in the cylinder, wherein the fuel in at least one stroke position of the piston 1 impinges on the second section 6b of the trough wall 6. Due to the missing or greatly reduced swirl, there is no danger that the fuel jets will be blown into each other, which would lead to high soot formation. As a result, more jets can be provided in the present swirl-reduced method than in comparable known swirl-bearing methods, for example more than nine, which additionally supports the fuel/air mixture formation.

The geometry of the piston 1 and the injection direction of the injection device 10 are coordinated so that—as viewed in a meridian section of the piston 1 located at top dead center OT—at least one jet axis Sa of an injection jet S of the injection device 10 subdivides the combustion chamber trough 3 into a lower region 3a and an upper region 3b, wherein the lower region 3a is approximately 54% to 62%, preferably 56%, and the upper region 3b is approximately 38% to 46%, preferably 44%, of the entire region of the combustion chamber trough 3 (FIG. 1).

Here, the start of the fuel injection is to be selected in the range of −6° to 0° crank angle before the top dead center OT of the piston 1. The injection duration is in the range of 35° to 42° crank angle. Through this selected division of especially 44 to 56 between the upper and lower regions of the combustion chamber trough 3, in combination with the start of the injection at −2° before top dead center OT, there is almost complete acquisition of the air mass available in the combustion chamber, which subsequently results in a very low-emission combustion. This division is shown in FIG. 13 with the piston position 10° after the top dead center OT. The soot formation occurring during the combustion process is almost completely suppressed by the nearly homogeneous fuel/air mixture. This utilization of the existing air mass also leads to a very efficient combustion with high burn-through speed, which is reflected in very good fuel consumption. This mass distribution allows a diesel combustion process which is also highly suitable for future emission standards.

The fuel jet S is divided by the rib-like projection of the second section 6b into a lower first jet part S1 and an upper second jet part S2, forming a first swirl roller T1 and a second swirl roller T2 with different directions of rotation. The jet splitting allows ideal utilization of the existing fresh air for combustion. Due to the convexly rounded, overhanging second section 6b, the kinetic energy of the fuel jet S can be deflected into the combustion chamber trough 3 with as little loss as possible. Jet pulse of the fuel jet S and shape of the trough wall 6 generate a double vortex or roller movement in the combustion chamber trough 3, which allows optimum utilization of the fresh air. The stepped design between the first annular surface 8 and the second annular surface 9 in the direction of the cylinder head distributes the impact of the hot combustion zone on the cylinder head to a larger area, thereby preventing or reducing a locally very high thermal load peak, as a result of which the thermal load on cylinder head can be reduced.

FIGS. 5 to 8 show the flow situation in the piston trough 3 for different crankshaft angles, wherein velocity vectors v for the air flow and the fuel flow are shown. The air/fuel ratio is indicated by gray scale, wherein the fuel concentration f is higher, the darker the gray levels are colored. FIG. 5 shows the flow situation in the region of the top dead center of the piston 1, FIG. 6 at 10° after top dead center, FIG. 7 at 20° after top dead center and FIG. 8 at 40° after top dead center of the piston 1. It can clearly be seen that in FIG. 8 only a relatively small fuel concentration f can be determined by a marked mixture leaning within the combustion chamber trough 3.

FIGS. 9 to 12 show the soot formation situation in the piston trough 3 for different crankshaft angles, wherein the soot concentration ST is indicated by gray scales. The soot concentration ST is the higher, the darker the gray levels are colored. FIG. 9 shows the soot situation in the region of the top dead center of the piston 1, FIG. 10 at 10° after top dead center, FIG. 11 at 20° after top dead center and FIG. 12 at 40° after top dead center of the piston 1. In FIG. 12, virtually no soot concentration ST is noticeable within the combustion chamber trough 3.

FIGS. 13 and 14 very clearly demonstrate the effect of the selection according to the invention of the third angle γ defined between the piston axis 2 and the second annular surface 9—between approximately 15° and 25°, preferably 21°. Due to said inclination of the second annular surface 9, the fuel jet S is directed in the direction of the cylinder wall 28, wherein the direct contact with the cylinder wall 28 can be avoided. This supports the maximum acquisition of available fresh gas charge for complete low-emission combustion. In this case, the fuel pulse generates a charge movement, which is formed in the form of a counterclockwise rotation of the injection jet S. This takes place both in the area between the piston 1 and the combustion chamber ceiling 29, and between the piston 1 and the trough bottom 4. The thus resulting rotating rollers T1, T2 are further fueled by the fuel jets and thereby allow an approximately homogeneous fuel/air mixture. This allows a very good and low-emission combustion to be achieved. This effect is shown in FIG. 14 with the piston position 25° after the top dead center OT. If the angle γ smaller than the specified 15°, the fuel jets S are reflected back into the combustion chamber trough 3, whereby the mixing with fresh gas is deteriorated. However, if the angle γ is greater than 25°, wetting of the cylinder wall 28 with fuel cannot be ruled out.

FIGS. 15 and 16 show a second embodiment of the invention, wherein the trough wall 6 has additional nose-like projections 30 or scoop-like or dome-like depressions 31 in the second region 6b, in addition to the rib-like circumferential projection. Conveniently, per injection jet S or injection hole 10 of the injection device 10, a nose-like projection 30 is provided. The nose-like projections 30 protrude in the radial direction into the combustion chamber trough 3 and are advantageously formed substantially symmetrically to a radial plane τ defined by the piston axis 2 and the injection axis Sa. As a result of the nose-like projections 30 and the recesses 31, the already explained effect of the division of the injection jet S is extended in the circumferential direction. The effect of mass division is complemented in the circumferential direction by the embossment of two recesses 31 per injection hole or injection jet S. The removal of the nose-like projections from the piston axis 2 is denoted by E1, the removal of the recesses 31 by E2. The ratio E1 to E2 is advantageously 0.75 to 0.95, wherein 8.88 has shown to be particularly favorable. The other geometric characteristics are identical to the first embodiment. This geometric arrangement divides the fuel jet S in the circumferential direction in equal parts into jet arms A1 and A2 and thus supports the formation of two counter-rotating mixture vortices W1 and W2. As a result, the available atmospheric oxygen is ideally fed to the combustion, which is reflected in a very low soot formation and specific fuel consumption. FIG. 16 illustrates this effect. The nose-like projection 30 is curved convexly similar to the circumferential projection in the second section 6b, wherein the radius of curvature R5 of the nose-like projection 30 may be, for example, 0.02 to 0.03 +/−50% of the diameter D of the piston 1.

The fuel jet S is divided through the nose-like projection 30, which extends from the first section 6a via the second section 6b to the third section 6c in the embodiment shown in FIGS. 15 and 16, into a lower first jet arm A1 and a second jet arm A2, wherein a first mixture vortex W1 and a second mixture vortex W2 arise with different directions of rotation. The splitting of the jet allows optimal utilization of the existing fresh air for combustion. As a result of the convexly rounded nose-like projection 30, the kinetic energy of the fuel jet S can be deflected with the lowest possible loss into the combustion chamber trough 3 on both sides of the radial plane τ. The jet pulse of the fuel jet S and the shape of the nose-like projection 30 of the trough wall 6 generate a double swirling movement in the combustion chamber trough 3, which is complemented by the double rolling movement by the rib-like circumferential projection in the second section 6b. All this together allows optimal utilization of the fresh air. The step-shaped design between the first annular surface 8 and the second annular surface 9 in the direction of the combustion chamber ceiling 29 formed by the cylinder head distributes the impact of the hot combustion zone on the cylinder head to a larger area, thereby preventing or reducing a locally very high thermal load peak, whereby the thermal load on the cylinder head can be reduced.

In this way, soot formation and coking phenomena on the piston 1 can be effectively prevented even in internal combustion engines, which are designed for swirl-free combustion processes. The piston 1 allows optimum mixture formation and smoke-free combustion of the fuel in internal combustion engines with swirl-free inlet structure.

1. An air compressing internal combustion engine, comprising at least one reciprocating piston (1), in particular for swirl-free or low-swirl combustion, having a combustion chamber trough (3) substantially rotationally symmetrical to a piston axis (2), which has a trough bottom (4) with a substantially cone-like elevation (5) and a circumferential trough wall (6), wherein the trough wall (6) forms a substantially torus-like first section (6a) adjoining the trough bottom (4) and having a maximum inner first trough diameter (d1), thereafter a second section (6b) forming a constriction and having a minimum inner second trough diameter (d2) smaller than the inner first trough diameter (d1), and thereafter a third section (6c) forming a trough rim section, wherein—as seen in a meridian section of the piston (1)—the first section (6a) has a concave first radius of curvature (R1) and the second section (6b) has a convex second radius of curvature (R2), and wherein the third section (6c) forms a first annular surface (8) adjoining the second section (6b) and a second annular surface (9) terminating in the piston end surface (7), which second annular surface (9) defines an angle (β) with the first annular surface (8), wherein the first annular surface (8) and the second annular surface (9) are formed to be inclined to a normal plane (ε) on the piston axis (2), and wherein in the transition between the first annular surface (8) and second annular surface (9) an edge (11) is formed with a defined third radius of curvature (R3), wherein as viewed in a meridian section of the piston (1), the first annular surface (8) together with a normal plane (ε) on the piston axis (2) forms a first angle (α) between 10° and 20°, preferably 15.2°.

2. The internal combustion engine according to claim 1, wherein as viewed in a meridian section, the first annular surface (8) encloses with the second annular surface (9) a second angle (β) between about 100° and 150°, preferably about 125°.

3. The internal combustion engine according to claim 1, wherein the second annular surface (9) defines with the piston axis (2) a third angle (γ) between about 15° and 25°, preferably 21°.

4. The internal combustion engine according to claim 1, wherein the inner second trough diameter (d2) is at most about 95% of the inner first trough diameter (d1).

5. The internal combustion engine according to claim 1, wherein based on the maximum diameter (D) of the piston (1), the combustion chamber trough (3) in the region of the first section (5a) has an inner first trough diameter (d1) of about 0.7±20%.

6. The internal combustion engine according to claim 1, wherein based on the maximum diameter (D) of the piston (1), the combustion chamber trough (3) in the region of the second section (6b) has an inner second diameter (d2) of about 0.65±20%.

7. The internal combustion engine according to claim 1, wherein based on a maximum diameter (D) of the piston (1), the first radius of curvature (R1) is about 0.06±50%.

8. The internal combustion engine according to claim 1, wherein based on a maximum diameter (D) of the piston (1), the second radius of curvature (R2) is about 0.02±50%.

9. The internal combustion engine according to claim 1, wherein based on a maximum diameter (D) of the piston (1), the third radius of curvature (R3) is at most about 0.012±50%.

10. The internal combustion engine according to claim 1, wherein the first annular surface (8) and/or the second annular surface (9) is or are formed as a conical surface.

11. The internal combustion engine according to claim 1, wherein in the region of the piston axis (2) an injection device (10) is arranged so that at least one fuel jet (S) impinges on the second section (6b) in at least one stroke position of the piston (1) and the fuel jet (S) can be divided by the second section (6b) into a first jet part (S1) directed towards the first section (6a) and a second jet part (S2) directed towards the third section (6c).

12. The internal combustion engine according to claim 1, wherein the internal combustion engine has a swirl-free or low-swirl inlet channel structure, wherein a swirl number of the flow in the combustion chamber about the piston axis (2) is at most 1.

13. The internal combustion engine according to claim 11, wherein as viewed in a meridian section of the piston (1) located at the top dead center, at least one jet axis (Sa) of the injection device (10) subdivides the combustion chamber trough (3) into a lower region (3a) adjoining the trough bottom (4) of the piston (1) and an upper region (3b) adjoining said lower region in the direction of the combustion chamber ceiling, wherein the lower region (3a) is approximately 54% to 62%, preferably 56%, and the upper region (3b) is approximately 38% to 46%, preferably 44%, of the entire combustion chamber trough (3).

14. The internal combustion engine according to claim 11, wherein the trough wall (6) has a nose-like projection (30) at least in an impact area of the fuel jet (S) on the second section (6b), wherein the projection (30) preferably continues into the region of the first section (6a) and/or third section (6c).

15. The internal combustion engine according to claim 11, wherein the nose-like projection (30) is formed substantially symmetrically to a radial plane (τ) of the piston (1) containing the piston axis (2).
